(19) United States
(12) Patent Application Publication
(10) Pub. No.: US 2018/0266729 A1
(43) Pub. Date: Sep. 20, 2018

(54) HIGHLY VERSATILE AND EASY TO ASSEMBLE HIGH-STRENGTH SUPPORT ASSEMBLY

(71) Applicant: Song-Ping SHANG, (US)

(72) Inventor: Pei-Lin DAI, Taichung City (TW)

(21) Appl. No.: 15/607,136

(22) Filed: May 26, 2017

(30) Foreign Application Priority Data
Mar. 20, 2017 (TW) 106109475

(51) Int. Cl. F24J 2/52; H02S 20/23

(52) U.S. Cl. CPC F24J 2/5201; E04B 2001/2415; H02S 20/23; F24J 2/5233

(57) ABSTRACT

The present invention discloses a high-strength support assembly structure, which utilizes a fastening cover part that can be slidably sleeved onto a C-type steel and an opening side thereof and a flexible internal stand; the flexible internal stand is placed inside of the C-type steel, and the internal stand and the fastening cover part are correspondingly fastened at the opening side of the C-type steel, such that the opening side of the C-type steel can serve as a connecting end or a bearing side. The present invention also discloses using or stacking a single or a plurality of connecting plates, so as to allow one C-type steel to be correspondingly joined to another C-type steel in order to expand a length thereof, or to adapt the C-type steel for serving as a corner.

### BACKGROUND OF THE INVENTION

### a) Field of the Invention

The present invention relates to a support assembly structure, and more particularly to a support assembly structure that is high-strength (resistant to deformation), highly versatile and easy to assemble.

### b) Description of the Prior Art

The common support structures that are used for supporting solar panels, greenhouse farming sheds, parking sheds or even furniture stands are mostly three-dimensional rectangular supports (as indicated in FIG. 15) formed by using steel materials as transverse beams W and longitudinal beams L.

The steel materials used as supports in the industry is divided into C-type steels, rectangular (round) tubes or H-type steels according to shapes of their cross sections; the C-type steels are most commonly used for setting up supports due to their high-strength, corrosion-resistance, ease of manufacturing and low costs.

However, upon observation of current C-type steels used for setting up supports (as indicated in FIG. 16), there are many unsolved problems with respect to manners of setting up or securing transverse and longitudinal beams.

The transverse beams and longitudinal beams W and L are mostly secured to each other by welding. For setting up supports, it is necessary to additionally prepare welding tools at the site of assembly, or carry out welding in a factory before transporting the supports to a working site. As a result, the transportation process and the versatility of the steel materials cannot be improved further, which leads to high costs. In addition, the quality of welding that joins transverse beams and longitudinal beams W and L can vary between workers, and a coated layer over the surface of a steel material can be melted (not shown in the figure) by high temperature during welding, subsequently leading to rusting and corrosion of weld generated from welding, which further impacts on steel strength.

There are a number of ways for setting up transverse beams and longitudinal beams W and L. Generally, the C-type steels can be divided into an A side A, two corresponding B sides B that are parallel to each other, and two C sides C according to structures thereof; each of the B sides B are formed by respectively bending and extending a long end and a corresponding long end thereto from the A side A, while each of the C sides C are respectively disposed on two long ends of the B sides B and then bent and extended to form a C-type steel structure having an opening side CX (as indicate in FIG. 15). In order to conveniently secure transverse beams and longitudinal beams W and L by screws, screw holes S are disposed with equal distances between each other on the A side A and the B sides B of the C-type steels, which leads to problems such as increasingly reduced production efficiency resulted from more screw holes S being disposed, and significant reduction in the steel strength and corrosion-resistance of the C-type steels that render the C-type steels more susceptible to deformation or corrosion by external forces. In addition, the ground formation at the site where the supports are to be assembled is hard to be known in advance, and if the screw holes S are preset on the A side A and the B sides B of the C-type steels, it would be impossible to carry out miniscule adjustments on the relative positions of the C-type steels.

Additionally, regardless of whether the C-type steels are used as the transverse beams W or the longitudinal beams L in a support assembly, the assembly is completed by setting the A side A in correspondence to the B sides B, and if a force is exerted on the B sides B of the C-type steels, the A side A on a single side of the C-type steels would be significantly deformed by the force (as indicated in FIG. 16). But if the force could be directed onto the A side A of the C-type steels, deformations is less likely to occur, and the reason is that when a force is exerted on the A side A, the B sides B located at both sides thereof also bear the force simultaneously, such that the force becomes more distributed and less likely to cause deformation. Similarly, if the C sides C corresponding to the A side A can serve as a surface for bearing the force, the force can be similarly distributed to the B sides B. However, since the C sides C have an opening side CX, it is not possible to dispose screw holes S thereon to make the C sides C serve as fastening sides, thus leading to the assembly method in which only B sides B are used to bear the force in the industry.

It can be known from the above-mentioned description that the C-type steels have at least one opening side CX that cannot be used as a fastening side, which leads to the inability of covering the opening side CX of the C-type steels. After long usage, it is found that the C-type steels are susceptible to rusting and corrosion internally that impacts on steel intensity thereof. For instance, a solar panel is often set up at seaside or in industrial areas, where highly corrosive substances (such as sulfur dioxide (SO₂) or chlorides (CI) and the like) are commonly present in the air, and the highly corrosive substances often drift into and become deposited at internal corners of the C-type steels (as indicated in FIG. 17) along with rain or sea breezes via the opening side CX (since the opening side CX is not covered with anything), thus causing rusting and corrosion that reduce the cross-sectional areas of the C-type steels and impair the original strength thereof.

Therefore, the inventor of the present invention has strived to solve the aforesaid disadvantages and shortcomings of the prior arts.

### SUMMARY OF THE INVENTION

A primary object of the present invention is to provide a highly versatile and easy to assemble high-strength support assembly structure, which utilizes a fastening cover part that can be slidably sleeved onto an opening side of a C-type steel and a flexible internal stand; the internal stand is correspondingly fastened to the fastening cover part from inside of the C-type steel, such that the C-type steel can employ a C side thereof to serve as a connecting end and a bearing side for securing a support.

Another object of the present invention is to provide a highly versatile and easy to assemble high-strength support assembly structure which utilizes a single or a plurality of connecting plates to correspondingly join two C-type steels so as to extend lengths thereof, or to adapt (a 90-degree angle combination to make a corner) the C-type steels for making a corner that form a support assembly. Accordingly, the C-type steels can be easily assembled and secured by using a single or a plurality of connecting plates for joining (extending lengths) and adapting (90-degree corner assembly) the C-type steels for making a three-dimensional rectangular support.

To achieve the aforesaid objects, the present invention provides a highly versatile and easy to assemble high-strength support assembly structure, comprising: at least a C-type steel having an opening side, a fastening cover part and at least a flexible internal stand; wherein the fastening cover part can be simultaneously sleeved onto two B sides (two corresponding sides) of the C-type steel and completely cover the opening side; the internal stand is correspondingly fastened to the fastening cover part located outside, from inside of the C-type steel and via the opening side thereof, and then serves as a connecting end or a bearing side.

According to the aforesaid primary object, wherein the flexible internal stand comprises: a rectangular base plate having long and short sides, flexible portions disposed at the periphery of the base plate to form an accommodating space and two auxiliary plates; the flexible portions respectively extend outwards from two corresponding short sides of the rectangular base plates, and free ends of the flexible portions are bent and extended to form a supporting portion, such that when the internal stand is correspondingly fastened to the fastening cover part from inside of the C-type steel, the internal stand bears a vertical compression force originating from a vertical fastening component, and the two flexible portions and the supporting portion at front ends thereof generate a flexible force corresponding to the compression force, which further allows the internal stand and the fastening cover part to be more tightly compressed into the C-type steel and combined integrally therewith.

According to the aforesaid primary characteristics, wherein the present invention further discloses a upper surface of the fastening cover part and an A side of the C-type steel can be respectively fastened to a connecting plate; when the connecting plate is rectangular in shape, the C-type steels can be joined to each other so as to extend lengths thereof, and when the connecting plate is L-shaped, the C-type steels can be adapted for forming a corner.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a three-dimensional exploded schematic view of a high-strength support assembly structure according to a first embodiment of the present invention, and shows pieces at openings of short sides of a fastening cover part being correspondingly fitted into opening sides of a C-type steel.

FIG. 2 is a three-dimensional exploded schematic view of the high-strength support assembly structure according to the first embodiment of the present invention, and shows pieces at openings of long sides of the fastening cover part being correspondingly fitted into the opening sides of the C-type steel.

FIG. 3 is a three-dimensional assembled schematic view of the high-strength support assembly structure according to the first embodiment of the present invention, and shows fastening components passing through a flexible internal stand from inside of the C-type steel, and are correspondingly fastened and secured to the fastening cover part via an opening side of the C-type steel.

FIG. 4 is a dissected schematic view of the high-strength support assembly structure according to the first embodiment of the present invention, and shows the fastening components passing through the flexible internal stand from inside of the C-type steel, and are correspondingly fastened and secured to the fastening cover part via the opening side of the C-type steel.

FIG. 5 is another dissected schematic view of the high-strength support assembly structure according to the present invention, and shows the flexible internal stand can be easily inserted into the opening side of the C-type steel and assembled therein.

FIG. 6 is another dissected schematic view of the high-strength support assembly structure in three-dimensional assembly according to the first embodiment of the present invention, and shows the opening side of the C-type steel serving as a connecting end.

FIG. 7 is another dissected schematic view of the high-strength support assembly structure in a different assembly according to the first embodiment of the present invention, and shows the opening side of the C-type steel serving as a connecting end.

FIG. 8 is a three-dimensional exploded schematic view of a high-strength support assembly structure according to a second embodiment of the present invention, and shows a fastening cover part being used in combination with a plurality of internal stands to allow two C-type steels to be correspondingly joined and extended as a whole.

FIG. 9 is another three-dimensional exploded schematic view of the high-strength support assembly structure according to the second embodiment of the present invention, and shows the fastening cover part being used in combination with a plurality of internal stands and being correspondingly fastened to a connecting plate in order to extend a length of the C-type steel.

FIG. 10 is yet another three-dimensional exploded schematic view of the high-strength support assembly structure according to the second embodiment of the present invention, and shows the fastening cover part being used in combination with a plurality of internal stands and being correspondingly fastened to a plurality of connecting plates, in order to extend the length of the C-type steel and enhance the strength of connection thereof.

FIG. 11 is a three-dimensional assembled schematic view of a high-strength support assembly structure according to a third embodiment of the present invention, and shows two C-type steels being correspondingly fastened via an L-shaped connecting plate in order to join a transverse beam to a longitudinal beam.

FIG. 12 is a three-dimensional assembled schematic view showing a different angle of the high-strength support assembly structure according to the third embodiment of the present invention, and shows two C-type steels being correspondingly fastened via an L-shaped connecting plate in order to join a transverse beam to a longitudinal beam.

FIG. 13 is a three-dimensional assembled schematic view of a high-strength support assembly structure according to a fourth embodiment of the present invention, and shows a connecting plate serving as a support stand and pivotally connected to an end portion of the C-type steel.

FIG. 14 is another three-dimensional assembled view of a high-strength support assembly structure according to the fourth embodiment of the present invention, and shows the support stand being pivotally connected to the end portion of the C-type steel and capable of rotating.

FIG. 15 is a three-dimensional schematic view of a conventional support structure.

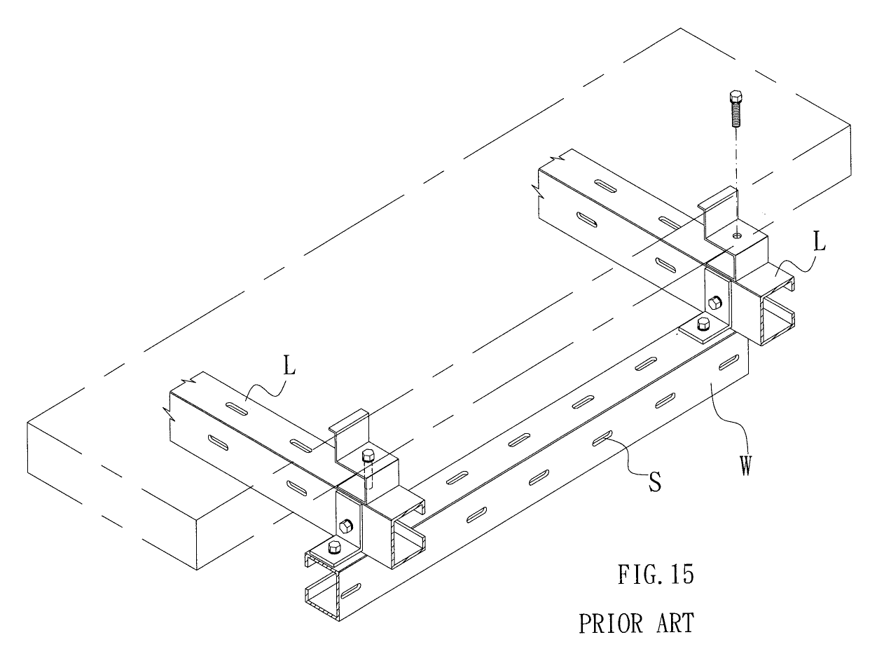

FIG. 16 is a dissected schematic view showing a conventional transverse beam being assembled with a conventional longitudinal beam, and indicates that an A side is deformed by force.

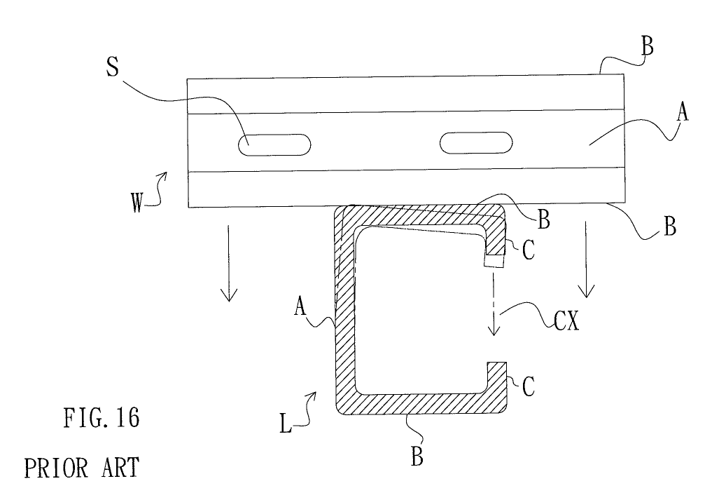

FIG. 17 is another dissected schematic view showing a conventional transverse beam being assembled with a conventional longitudinal beam, and indicates the opening side is open to rain and sea breezes, which leads to rusting and corrosion at internal corners that reduces a cross-sectional area of the C-type steel.

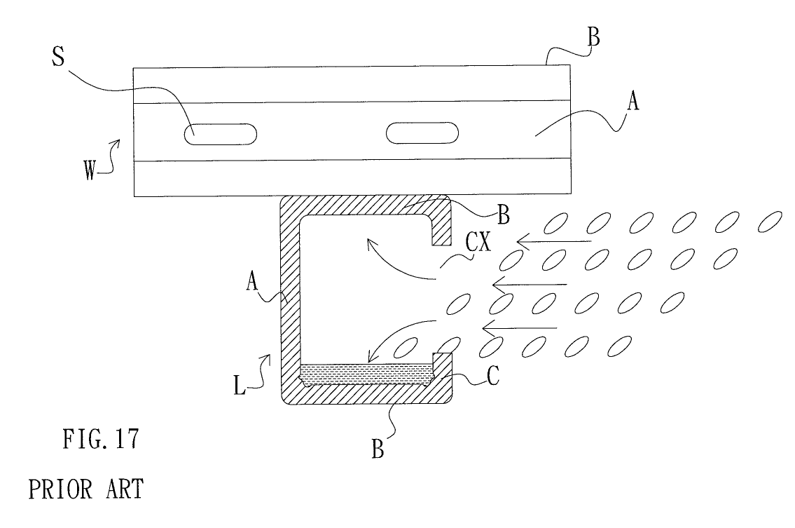

### DETAILED DESCRIPTION OF THE PREFERRED EMBODIMENTS

To achieve the above-mentioned purposes and effects, figures based on preferred embodiments of the present invention are provided to illustrate characteristics and purposes of the technical means and structures employed in the present invention, so as to facilitate full understanding thereof.

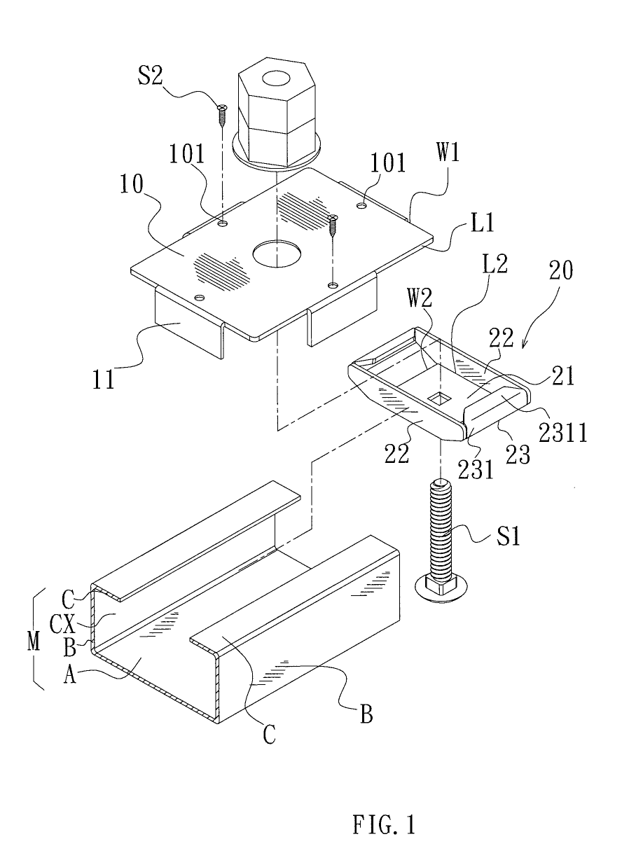

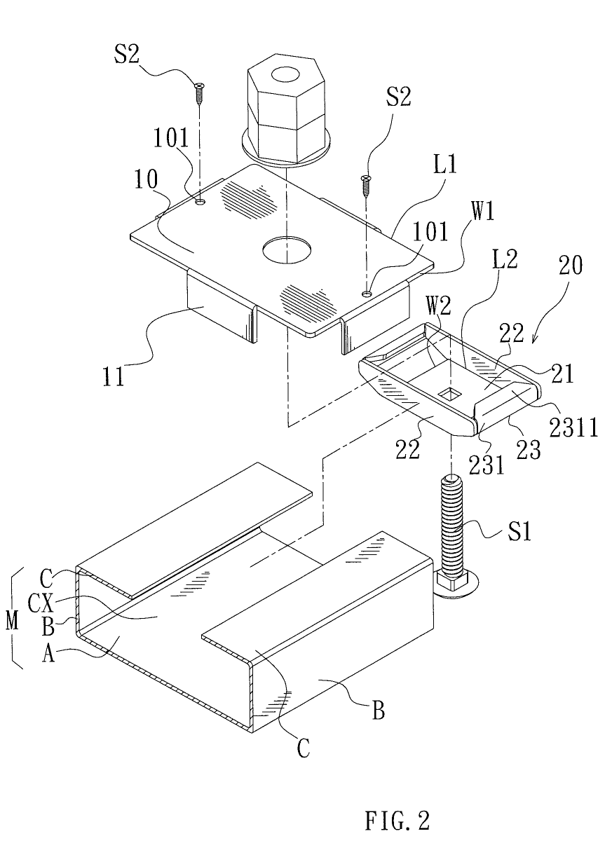

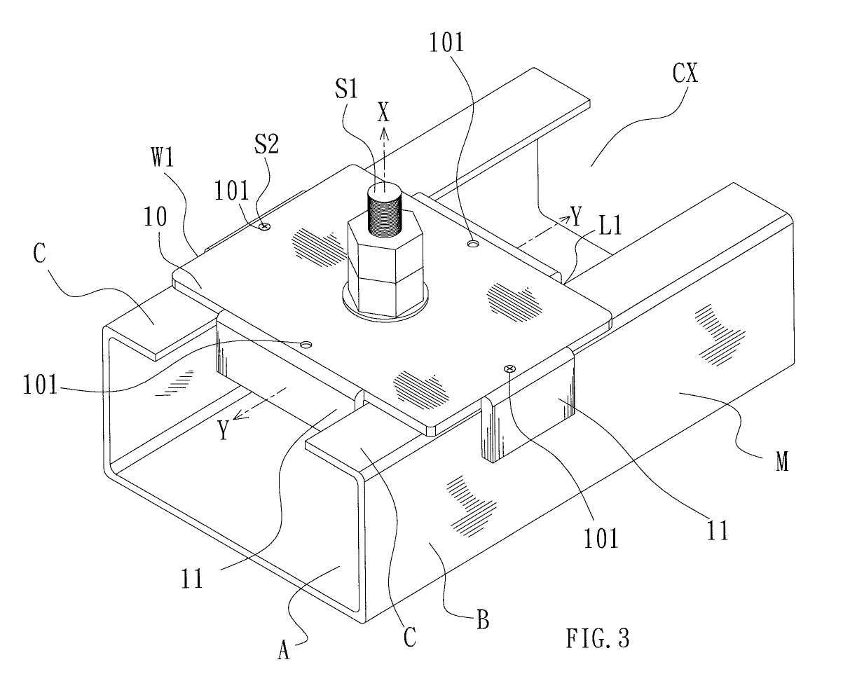

Referring to FIGS. 1-3; FIG. 1 is a three-dimensional exploded schematic view of a high-strength support assembly structure according to a first embodiment of the present invention, and shows pieces at openings of short sides of a fastening cover part being correspondingly fitted into opening sides of a C-type steel; FIG. 2 is a three-dimensional exploded schematic view of the high-strength support assembly structure according to the first embodiment of the present invention, and shows pieces at openings of long sides of the fastening cover part being correspondingly fitted into the opening sides of the C-type steel; FIG. 3 is a three-dimensional assembled schematic view of the high-strength support assembly structure according to the first embodiment of the present invention, and shows fastening components passing through a flexible internal stand from inside of the C-type steel, and are correspondingly fastened and secured to the fastening cover part via an opening side of the C-type steel.

As indicated in the above figures, the present invention provides a highly versatile and easy to assemble high-strength support assembly structure, comprising: at least one C-type steel M having an opening side CX, a fastening cover part 10 and at least one flexible internal stand 20 (as shown in FIG. 1), wherein the fastening cover part 10 completely covers two C sides C of the C-type steel M, and by using a vertical fastening component S1, the internal stand 20 is correspondingly and integrally fastened to the fastening cover part 10 at outside (as indicated in FIG. 3) from inside of the C-type steel M and via the opening side CX. When the flexible internal stand 20 is correspondingly fastened to the fastening cover part 10 but not yet completely fastened and secured, the fastening cover part 10 can be freely slid in a sliding track on a surface (C side C) of the C-type steel M and adjusted positionally in order to facilitate positioning thereof, that is: the purpose of the fastening cover part 10 of the present invention is to fasten and cover the opening side CX of the C-type steel M, such that the opening side CX can be used as a connecting end or a bearing end; the fastening cover part 10 has at least two corresponding long sides L1 and two corresponding short sides W1, and both the long sides L1 and the short sides W1 are bent and extended to form at least one opening piece 11; the opening piece 11 can be embedded into the opening side CX of the C-type steel M or sleeved onto the two B sides B (two corresponding sides) of the C-type steel M according to actual needs; as the opening piece 11 is embedded into the opening side CX, the opening side CX is prevented from deformation when the C-type steel M is under stress (as shown in FIG. 3). In addition, sizes of the long sides L1 and the short sides W1 of the fastening cover part 10 of the present invention can be varied according to different sizes of the C-type steel M. Depending on an external size of the C-type steel M, the opening pieces 11 of the long sides L1 or of the short sides W1 of the fastening cover part 10 can be sleeved onto two B sides B (two corresponding sides) (as indicated in FIGS. 1 and 2) so as to completely cover the opening side CX.

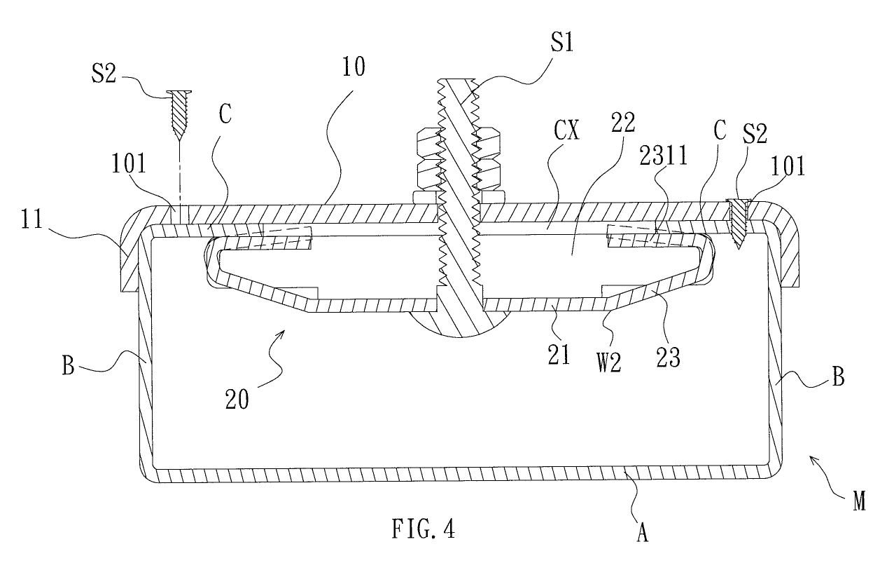

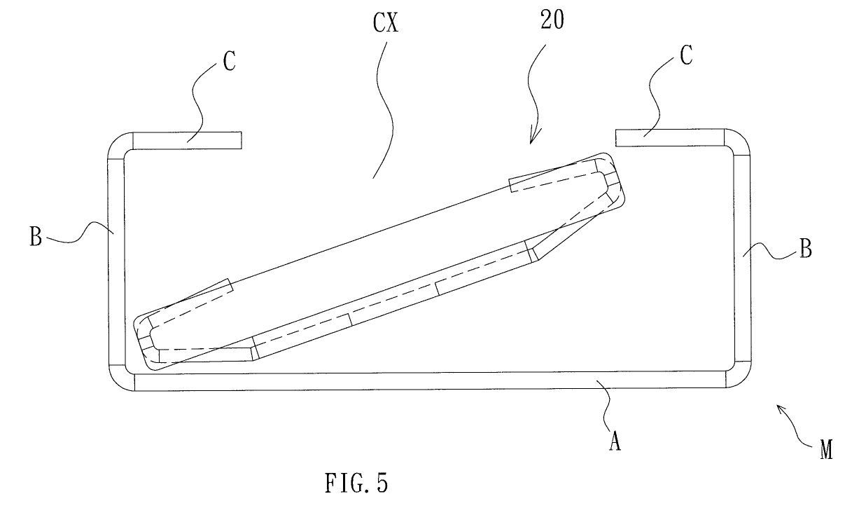

Referring to FIGS. 1 and 3-5; FIG. 4 is a dissected schematic view of the high-strength support assembly structure according to the first embodiment of the present invention, and shows the fastening components passing through the flexible internal stand from inside of the C-type steel, and are correspondingly fastened and secured to the fastening cover part via the opening side of the flexible internal stand. FIG. 5 is another dissected schematic view of the high-strength support assembly structure according to the present invention, and shows the flexible internal stand can be easily inserted into the opening side of the C-type steel and assembled therein.

As indicated in the figures above, the flexible internal stand 20 of the present invention (as shown in FIG. 1) comprises: a rectangular base plate 21 having long sides L2 and short sides W2, and the two corresponding long sides L2 of the base plate 21 are extended to form auxiliary plates 22; the two corresponding short sides W2 of the base plate 21 are respectively bent and extended upwards to form a flexible portion 23, and the flexible portion 23 has a free end 231 being bent and extended to form a supporting portion 2311; when the internal stand 20 is correspondingly fastened to the fastening cover part 10 at outside from inside of the C-type steel M by using a vertical fastening component S1 (as shown in FIGS. 3 and 4), the internal stand 20 bears a compression force generated by the vertical fastening component S1, such that the flexible portion 23 and the supporting portion 2311 generate a flexible force in response to the compression force, thus allowing the internal stand 20 and the fastening cover part 10 to be more tightly fastened together on the C-type steel M without loosening, and effectively countering a high-strength vertical stress X. It can be known from the above description that the present invention discloses using a vertical holding force generated from the tight fastening between the fastening cover part 10 and the flexible internal stand 20 to counter the high-strength vertical stress. However, the vertical holding force being used to counter a horizontal stress from another axis can be varied between different purposes (different industries), which leads to different requirements for dealing with the horizontal stress. Accordingly, the fastening cover part 10 of the present invention can be further added with at least one fastening hole 101 at edges on a upper surface thereof that is corresponding to the C sides C, as the fastening cover part 10 can be freely slid in a sliding track on a surface (C side C) of the C-type steel M and adjusted positionally, it is only necessary to tightly and integrally fasten the fastening cover part 10 to the flexible internal stand 20 in a vertical manner, or further using at least one horizontal fastening component S2 to be fastened into the C side of the C-type steel M via the fastening hole 101, thereby allowing the fastening cover part 10 and the flexible internal stand 20 to counter the horizontal stress and preventing the fastening cover part 10 from accidentally sliding off the C-type steel M (as shown in FIG. 3).

Further, during actual assembling of the internal stand 20 of the present invention, it is only necessary to directly embed the internal stand 20 into the opening side CX at a mid-section of the C-type steel M (as shown in FIG. 5), without having to embed the internal stand 20 from a front end or a rear end of the C-type steel M (not shown in the figure), thus making assembly thereof highly convenient.

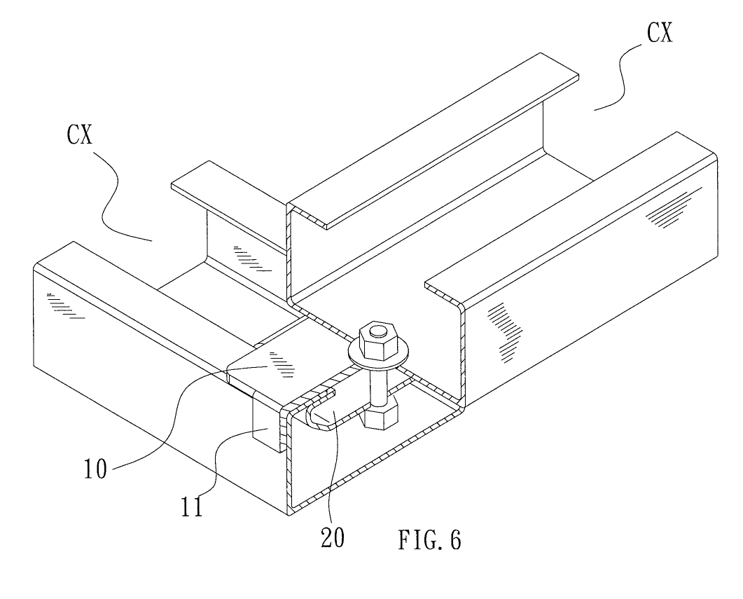

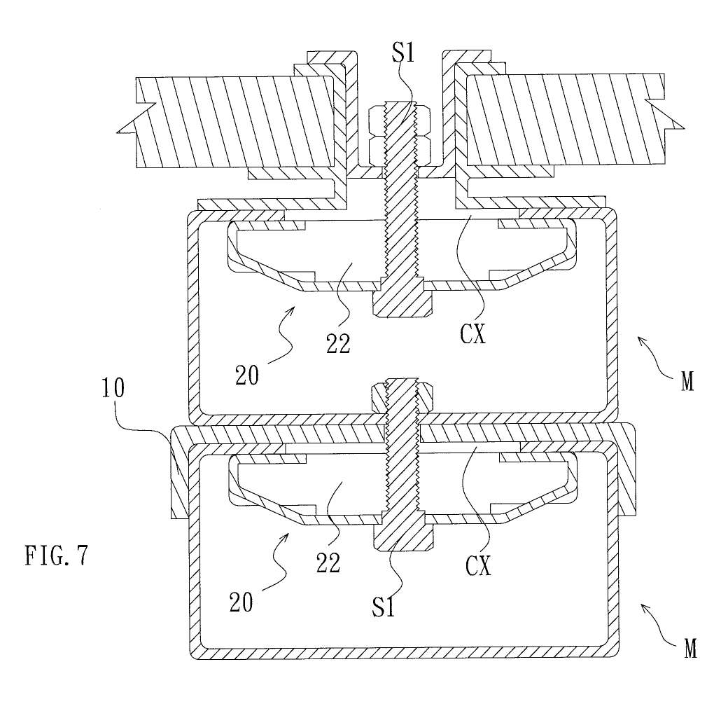

Referring to FIGS. 6 and 7; FIG. 6 is another dissected schematic view of the high-strength support assembly structure in three-dimensional assembly according to the first embodiment of the present invention, and shows the opening side of the C-type steel serving as a connecting end. FIG. 7 is another dissected schematic view of the high-strength support assembly structure in a different assembly according to the first embodiment of the present invention, and shows the opening side of the C-type steel serving as a connecting end.

As shown in the figures; by utilizing a vertical fastening component S1, the internal stand 20 of the present invention is correspondingly fastened to the fastening cover part 10 at outside from inside of the C-type steel M via the opening side CX, which effectively achieving a high-strength assembly. Furthermore, an end portion of the fastening component S1 can serve as a connecting end for combining with another C-type steel M, thus fully utilizing the C sides C of the C-type steel M and the opening side CX thereof for achieving integral combination (as shown in FIGS. 6 and 7).

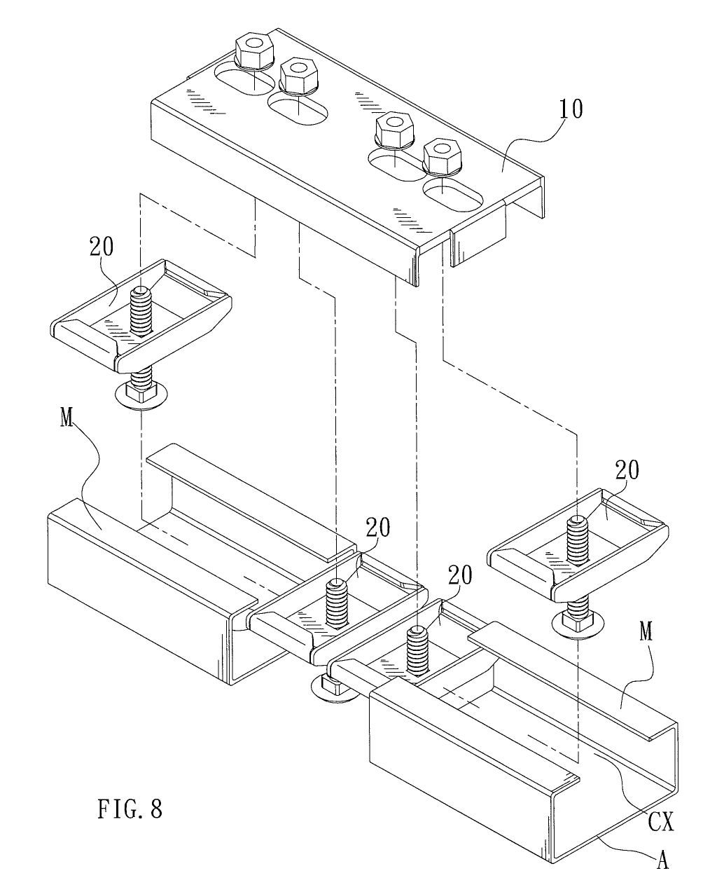

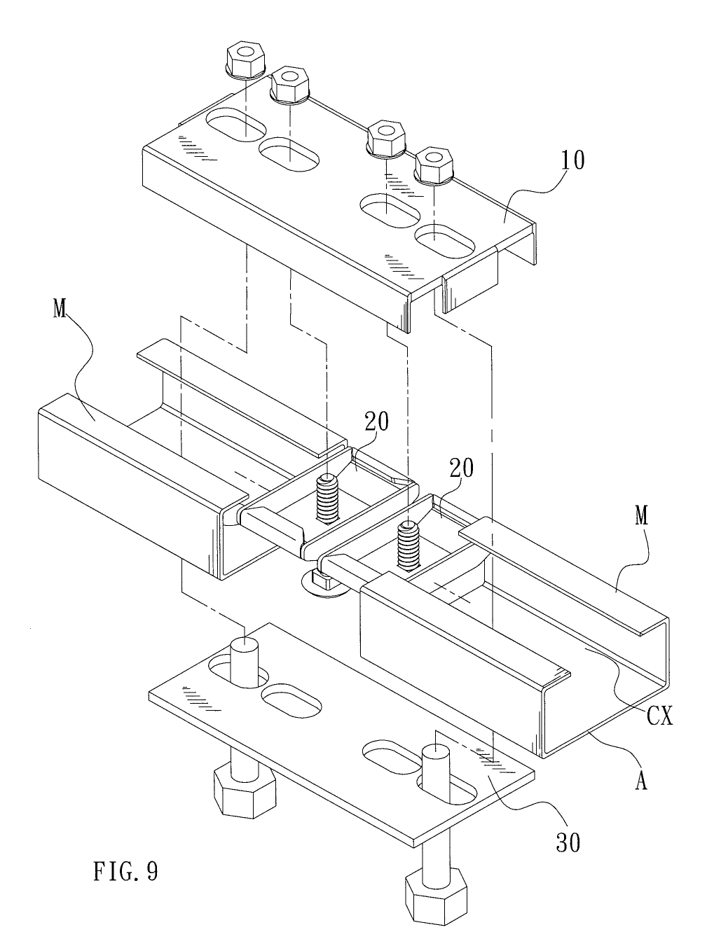

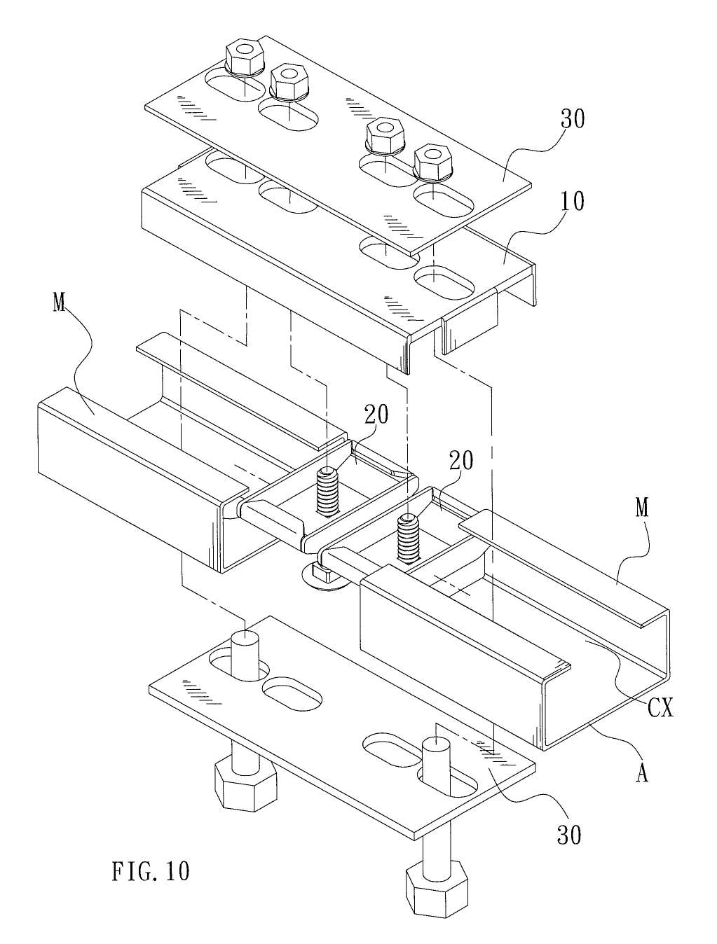

Referring to FIGS. 8 to 10; FIG. 8 is a three-dimensional exploded schematic view of a high-strength support assembly structure according to a second embodiment of the present invention, and shows a fastening cover part being used in combination with a plurality of internal stands to allow two C-type steels to be correspondingly joined and extended as a whole. FIG. 9 is another three-dimensional exploded schematic view of the high-strength support assembly structure according to the second embodiment of the present invention, and shows the fastening cover part being used in combination with a plurality of internal stands and being correspondingly fastened to a connecting plate in order to extend a length of the C-type steel. FIG. 10 is yet another three-dimensional exploded schematic view of the high-strength support assembly structure according to the second embodiment of the present invention, and shows the fastening cover part being used in combination with a plurality of internal stands and being correspondingly fastened to a plurality of connecting plates, in order to extend the length of the C-type steel and enhance the strength of joining thereof.

According to the present invention, the fastening cover part 10 can be used to cover and fasten the opening side CX of the C-type steel M, such that the opening side CX can serve as a connecting end or a bearing end. It should be noted that the present invention is not limited to using a single fastening cover part 10 in combination with a single internal stand 20. The fastening cover part 10 of the present invention can also be used in combination with a plurality of internal stands 20, so as to correspondingly join two C-type steels M and extend lengths thereof (as shown in FIG. 8). If using a single fastening cover part 10 is considered to be insufficient in strength, at least a rectangular (or I-shaped) connecting plate 30 can be fastened to a side corresponding to the opening sides CX (equivalent to the A side) of two C-type steels M (as shown in FIG. 9), or on top of the fastening cover part 10 (as shown in FIG. 10), so as to effectively enhance the joining of two C-type steels M.

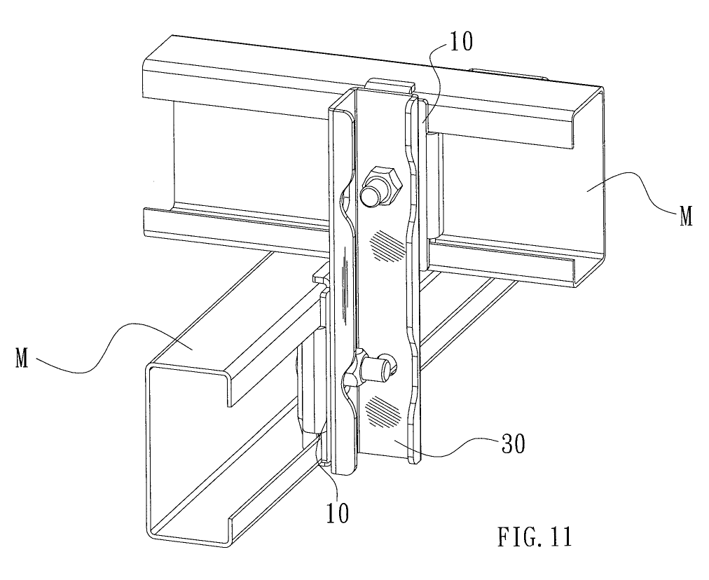

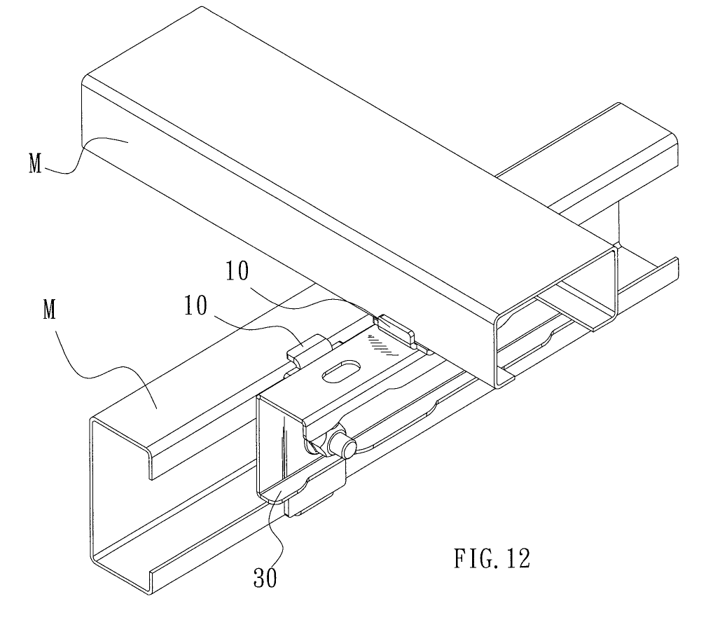

Referring to FIGS. 11 and 12; FIG. 11 is a three-dimensional assembled schematic view of a high-strength support assembly structure according to a third embodiment of the present invention, and shows two C-type steels being correspondingly fastened via an L-shaped connecting plate in order to connect a transverse beam to a longitudinal beam. FIG. 12 is a three-dimensional assembled schematic view showing a different angle of the high-strength support assembly structure according to the third embodiment of the present invention, and shows two C-type steels being correspondingly fastened via an L-shaped connecting plate in order to connect a transverse beam to a longitudinal beam.

When using the present invention as a support, it is necessary to combine a plurality of C-type steels M to form a corner structure or to adequately extend lengths thereof to meet actual requirements during assembling. The rectangular connecting plate 30 can not only be used to correspondingly join two C-type steels M to extend the lengths of the C-type steels M, but also used to turn two C-type steels M into a corner structure for meeting various requirements during assembling, which is highly flexible and versatile. Further, a shape of the connecting plate 30 of the present invention is not limited to any particular shapes and can be varied according to actual requirements or requirements for strength, and the connecting plate 30 can be rectangular, trapezoid, L-shaped, ladder-shaped or having an L-shaped cross section. When two C-type steels M are combined to form a corner structure, it is only necessary to use a connecting plate 30 in L-shape or having an L-shaped cross section (as shown in FIGS. 11 and 12) to combine the C-type steels M serving as transverse beams and longitudinal beams into a corner that can further form a rectangular support (not shown in the figures), thereby achieving a strengthened support structure that is highly versatile and easy to assemble.

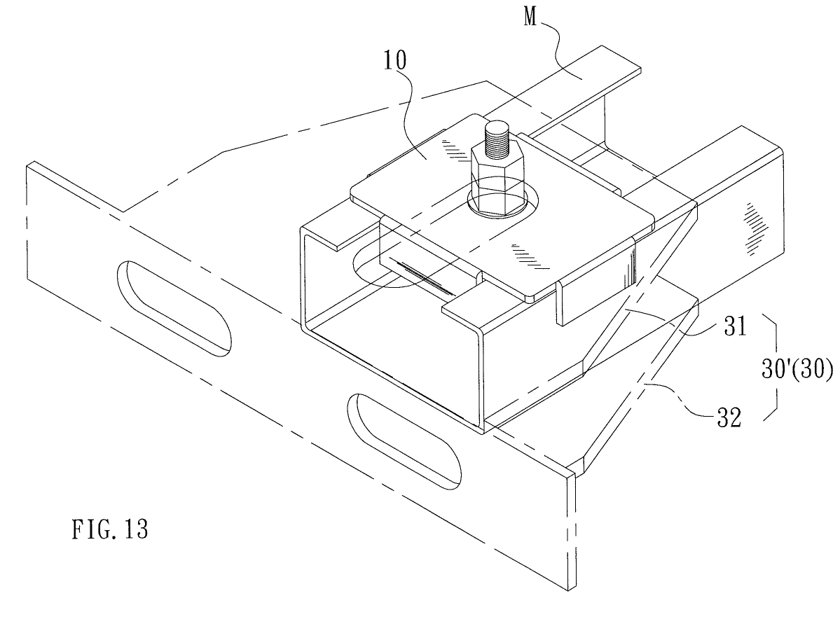

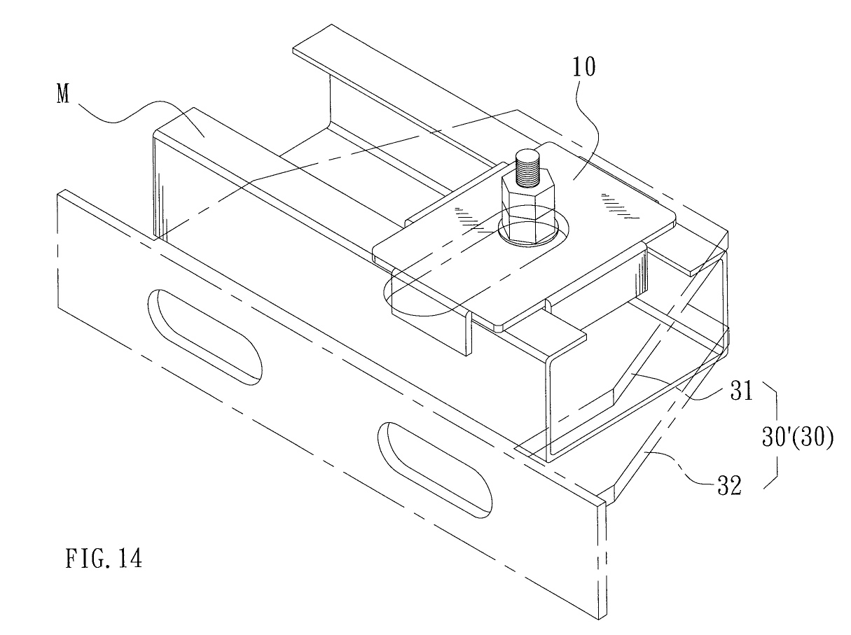

Referring to FIGS. 13 and 14; FIG. 13 is a three-dimensional assembled schematic view of a high-strength support assembly structure according to a fourth embodiment of the present invention, and shows connecting plates serving as a support stand and pivotally connected to an end portion of the C-type steel. FIG. 14 is another three-dimensional assembled view of a high-strength support assembly structure according to the fourth embodiment of the present invention, and shows the support stand being pivotally connected to the end portion of the C-type steel and capable of rotating.

Additionally, the connecting plate 30 can not only be used as an extension or a corner of supports, but also used singularly as a support stand 30′ (as shown in FIG. 13); the support stand 30′ has connecting plates 31 and 32 extendingly formed in correspondence to a upper surface and a lower surface of the C-type steel M, in which the connecting plates 31 and 32 are parallel to each other; the connecting plates 31 and 32 are respectively and pivotally connected to a surface of the fastening cover part 10 and a lower surface of the C-type steel M via an end portion of the C-type steel M, such that the support stand 30′ can freely rotate around the end portion of the C-type steel M (as shown in FIG. 14) and readily adapt to the ground formation at an assembly site. However, the connecting plate 30 disclosed in the present invention is not limited thereto, and a person in charge of assembling can freely make full use of the flexibility of the C-type steel M.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A highly versatile and easy to assemble high-strength support assembly structure, comprising:
at least a C-type steel having at least one opening side on a surface thereof;
a fastening cover part having two corresponding long sides and two corresponding short sides being bent and extended downwards to form at least one opening piece capable of being embedded into the opening sides, and the fastening cover part is sleeved onto the surface of the C-type steels and completely covers the opening sides; and
at least one flexible internal stand being correspondingly fastened to the fastening cover part at outside from inside of the C-type steels via the opening sides.

2. The highly versatile and easy to assemble high-strength support assembly structure of claim 1, wherein the internal stands include a rectangular base plate having long sides and short sides, and a flexible portion being disposed at periphery of the base plate to form an accommodating space and auxiliary plates; the flexible portion has another end being bent to form at least one supporting portion.

3. The highly versatile and easy to assemble high-strength support assembly structure of claim 1, further comprising at least one connecting plate being correspondingly fastened to the C-type steels from above or from below.

4. The highly versatile and easy to assemble high-strength support assembly structure of claim 3, wherein the connecting plates can be I-shaped, L-shaped or ladder-shaped.
